(19) United States
(12) Patent Application Publication
(10) Pub. No.: US 2003/0035205 A1
(43) Pub. Date: Feb. 20, 2003

(54) Fiber optic sensor signal amplifier

(76) Inventor: Edward J. Zisk JR., Kingwood, TX (US)

Correspondence Address: CANTOR COLBURN LLP, 55 Griffin Road South, Bloomfield, CT, 06002, US

(21) Appl. No.: 10/218,382

(22) Filed: Aug. 14, 2002

Related U.S. Application Data
(60) Provisional application No. 60/313,535, filed on Aug. 20, 2001.

(51) Int. Cl. H01S 3/00

(52) U.S. Cl. 359/341.3

(57) ABSTRACT

An apparatus and method for the fiber optic sensing of an amplified signal using Stimulated Raman Scattering in a wellbore. The apparatus includes a fiber optic communication medium extending from a well head of the wellbore to a downhole environment of the wellbore, a light source, a detector, and a signal pump all being in photo-communication with the fiber optic communication medium and positionable proximate the well head, and at least one fiber optic sensing device in photo-communication with the fiber optic communication medium being positionable downhole in the wellbore. The method of using the apparatus allows for the determination of downhole parameters associated with the wellbore and includes inputting at least two optical signals having differing wavelengths into the fiber optic communication means, returning an amplified signal from a fiber optic sensing device, and detecting the amplified signal.

### CROSS REFERENCE TO RELATED APPLICATIONS

This application claims the benefit of an earlier filing date from U.S. Provisional Application Serial No. 60/313,535 filed Aug. 20, 2001, the entire disclosure of which is incorporated herein by reference.

### BACKGROUND

Raman amplification involves the excitation of molecules from a lower energy state to a higher energy state due to the absorption of photons associated with an input signal. The principles of Raman amplification are used in the telecommunications industry where an optical signal is transmitted by a first apparatus and received by a remotely located second apparatus. An intermediate apparatus provides an input signal that supplements the transmitted optical signal and provides amplification of the optical signal to reduce the amount of its deterioration as a result of its propagation over long distances. In such applications, the goal to be attained is the throughput of the optical signal in order to provide informational communication between the apparatuses of transmission and reception.

For oilfield operations, however, the goal to be attained is not throughput of an optical signal as it is in the telecommunications industry, but is instead the transmission to and return of an optical signal from a downhole location. In a wellbore, the reception and detection of an optical signal is a function of its returnability from a downhole-located fiber optic sensing device. As such, the transmission and the reception both occur at a single point or at least at points that are in close proximity to each other. Because the optical signals are unamplified, they may be weak, thereby possibly rendering them unreadable or as having a significantly reduced dynamic range. A weak optical signal oftentimes contributes to a reduction in the accuracy of downhole measurements, which can adversely affect the drilling and maintenance operations taking place within the downhole environment.

### SUMMARY

An apparatus and method for amplifying the optical signals of remotely located fiber optic sensors through the use of Stimulated Raman Scattering (SRS) is disclosed herein. The apparatus includes a fiber optic communication medium extending from a well head of a wellbore to a downhole environment of the wellbore, a light source, a detector, and a signal pump all being in photo-communication with the fiber optic communication medium and positionable proximate the well head, and at least one fiber optic sensing device in photo-communication with the fiber optic communication medium being positionable downhole in the wellbore. The light source is configured to transmit a first optical signal having a characteristic wavelength spectrum through the fiber optic communication medium, and the signal pump is configured to transmit a second optical signal having a characteristic wavelength spectrum that is different than the characteristic wavelength of that of the light source through the fiber optic communication medium. The fiber optic sensing devices are configured to receive the optical spectrum from the light source and return a signal, that is amplified by the signal pump, at a wavelength that can be interpreted and quantified by the detector.

The method of using the apparatus includes inputting at least two series of optical signals having differing wavelengths into the fiber optic communication means, returning an amplified signal from a fiber optic sensing device, and detecting the sensor signal. The method is used relative to a wellbore in a downhole oilfield operation to determine parameters associated with the wellbore.

### BRIEF DESCRIPTION OF THE DRAWINGS

For a detailed understanding of the disclosed invention, reference should be made to the following detailed description, taken in conjunction with the accompanying drawings, in which like elements have been denoted by like numerals, wherein:

FIG. 1 is a schematic illustration of a wellbore having a fiber optic sensor signal amplification system incorporated therein;

FIG. 2A is a schematic illustration of the fiber optic sensor signal amplification system in which an optical signal is propagated in the downhole direction through a fiber optic communication medium comprising a strand of optic fiber;

FIG. 2B is a schematic illustration of the fiber optic sensor signal amplification system in which an optical signal is being returned from the downhole environment through the fiber optic communication medium.

FIG. 3 is a schematic illustration of an alternate embodiment of the fiber optic sensor signal amplification system; and

FIG. 4 is a schematic illustration of an alternate embodiment of the fiber optic sensor signal amplification system in which the fiber optic communication medium is a continuous loop of optic fiber.

### DETAILED DESCRIPTION

Stimulated Raman Scattering (SRS) occurs when molecules of a carrier material are excited from a ground level to a higher energy level by the absorption of photons associated with an input pumped signal. These pumped photons have high energy (and short wavelengths). The return of the excited molecules of the carrier material to an intermediate level results in the emission of photons having a characteristic wavelength in the range of about 13 to 15 terahertz (THz) below the frequency of the light resulting from the emission of photons associated with the input pumped signal. In addition to the emission of the photons of characteristic wavelength, the transition from the intermediate level back to the ground level results in the scatter of photons off the vibrational modes of the lattice matrix structure of the carrier material to form optical phonons. This scatter of optical phonons depends upon the molecular structure of the core of the carrier medium. The optical phonons are then coherently added to the low energy (and long wavelengths) of the optical signal to result in the amplified signal.

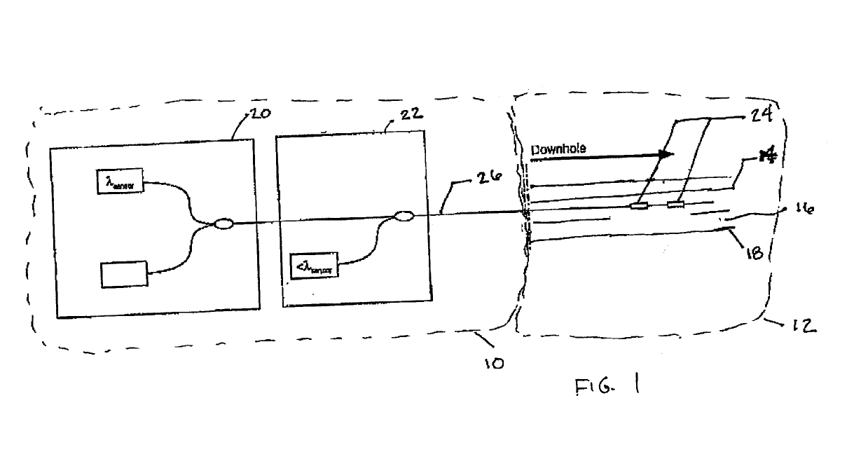

Referring to FIG. 1, a fiber optic sensor signal amplification system, shown generally at 10 and hereinafter referred to as “system 10”, is incorporated into a wellbore, shown generally at 12. System 10 is located at and operated from the well head of wellbore 12 and may extend into wellbore 12 either through a tubing string 14 (as shown) or through an annulus 16 formed by the concentric arrangement of tubing string 14 inside a casing 18.

System 10 utilizes a fiber optic configuration to reflectively transmit an optical signal. The fiber optic configuration comprises a carrier material, through which the reflected optical signal is transmitted. Stimulated Raman Scattering is used to amplify the optical signal and to increase the distance over which the optical signal can be transmitted through the carrier material while maintaining the required amplitude of the optical signal. The returned optical signal is subsequently interpreted and converted to a numerical value, which is used to determine various parameters associated with wellbore 12.

System 10 comprises a fiber optic sensor demodulator, shown generally at 20, a signal pump, shown generally at 22, at least one fiber optic sensing device 24, and the carrier material, which is a fiber optic communication medium 26 connecting fiber optic sensor demodulator 20, signal pump 22, and fiber optic sensing device 24 to provide photo-communication therebetween.

It should be recognized by one of ordinary skill in the art that the carrier material may comprise a plurality of fiber optic communication mediums 26 arranged in a parallel configuration. In such an arrangement, each fiber optic communication medium 26 serially connects fiber optic sensor demodulator 20, signal pump 22, and fiber optic sensing device 24. Each separate fiber optic communication medium 26 may further be deployed in a different wellbore or multilateral wellbores originating from the same wellbore. An optical switching device (not shown) may be used to selectively control signal output to the various fiber optic communication mediums 26. An optical coupling device (not shown) may also be used to provide for the monitoring and control of multiple fiber optic communication mediums 26 simultaneously. Various configurations of both types of devices are widely available commercially from a multitude of suppliers including, but not being limited to JDS Uniphase in San Jose, Calif.

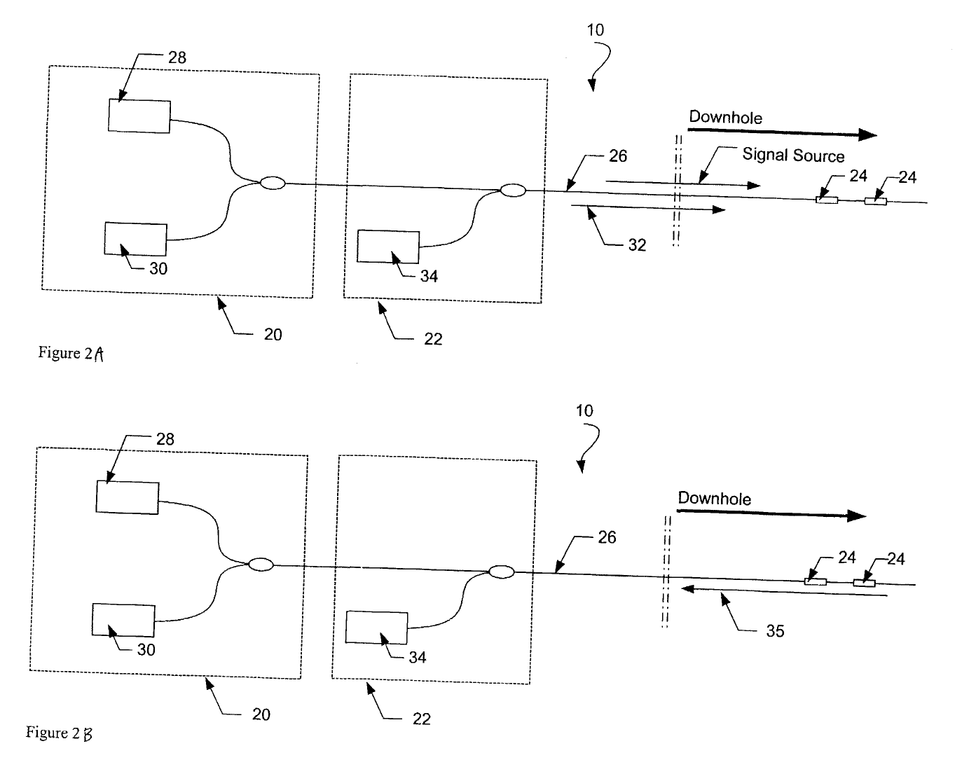

Referring now to FIGS. 2A and 2B, various components of system 10 are described in greater detail. Fiber optic sensor demodulator 20 comprises a light source 28 and a detector 30 in communication therewith. Light source 28 generates a wavelength spectrum that propagates through fiber optic communication medium 26 in a downhole direction, as indicated by an arrow 32.

As is shown in FIG. 2A, signal pump 22, which comprises a pump laser 34, propagates a pumped output pulse (<λₛₑₙₛₒᵣ) through fiber optic communication medium 26 in the downhole direction of arrow 32 and supplements the returning wavelength (see FIG. 2B) from fiber optic sensing device 24 (λₛₑₙₛₒᵣ). The pumped output of signal pump 22 is of a wavelength that is less than the wavelength returning from fiber optic sensing device 24. The pumped output pulse may also be of a wavelength that is greater than the wavelength returning from fiber optic sensing device 24. In either case, the pumped output introduced by signal pump 22 causes the output signal received from fiber optic sensing device 24 to be amplified. For other sensor amplification systems, signal pump 22 can be pulsed, or modulated, and demodulator light source 28 can remain at a steady state. The returning sensor signal would vary between amplified and unamplified states based on the signal pump frequency. In another sensor amplification system, both the signal pump and the demodulator light source can be pulsed, or modulated, in phase such that the returning signal from the fiber optic sensing device is amplified. In still another sensor amplification system, the sensor demodulator light source may be a pulsed, or modulated, signal and the signal pump can be at a steady state. Amplification of the signal from fiber optic sensor device 24 allows the sensor signal to be received from distances of about 100 kilometers with minimal deterioration of its amplitude, thereby allowing it to be more effectively detected.

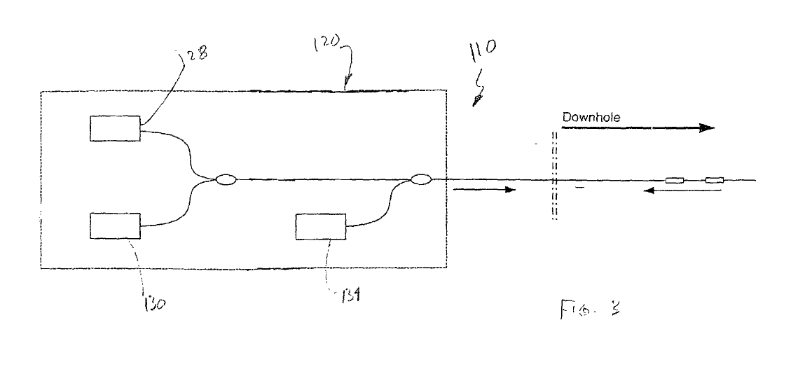

In another embodiment, shown generally at 110 in FIG. 3, the signal pump and the fiber optic sensor demodulator may be combined into a demodulator/signal pump assembly 120 comprising a light source 128, a detector 130, and a pump laser 134 to facilitate the use and placement of system 110 at the well head or within the wellbore. Location of either system 10 as shown in FIGS. 2A and 2B or system 110 is not, however, limited to the wellhead or within the wellbore. Due to the extended range afforded by the amplification, the system can be located remote to the wellhead. The remote location of either system would facilitate sub-sea installations where the system can be located at a platform that supports several subsea wellheads connected by tie-backs.

Referring again to both FIGS. 2A and 2B, the combined output signal is transmitted through fiber optic communication medium 26, which is a length of optical fiber capable of receiving optical signals. Propagation of an optical signal through optical fiber is a function of the attenuation of the optical signal within the microscopic substructure of the fiber material. Imperfections in the fiber material, in conjunction with the density thereof, enhance the stimulated scattering of light, thereby causing attenuation of the light and effectuating its propagation through fiber optic communication medium 26. Fiber optic communication medium 26 includes a relatively small core diameter of single mode fiber to support discrete downhole interferometer or bragg grating sensors. Other embodiments may incorporate the use of discrete sensors that utilize multimode fiber, which has a larger core diameter.

Fiber optic sensing devices 24 are positioned downhole and are in communication with fiber optic communication medium 26. As is shown in FIG. 2B, fiber optic sensing devices 24 are configured to sense and return the output signal in the direction of an arrow 35 back to detector 30 associated with fiber optic sensor demodulator 20 at a wavelength (λₛₑₙₛₒᵣ) that is equal to the wavelength reflected from fiber optic sensing device 24. The signal from fiber optic sensing device 24 (λₛₑₙₛₒᵣ) is amplified during its return to detector 30 by the signal pump 22 through the Raman amplification process.

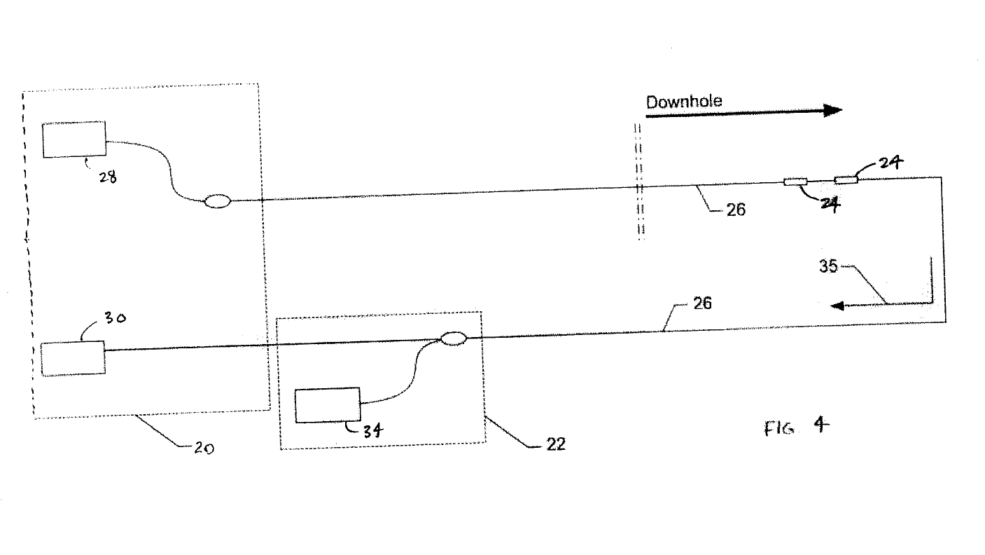

In FIGS. 2A and 2B, fiber optic communication medium 26 is shown as being a single strand of optic fiber, thereby necessitating the return of the combined output signal to detector 30 along the same path as the output pulse from light source 28 and the pumped output of pump laser 34. In FIG. 4, fiber optic communication medium 26 is shown as being a continuous loop of optic fiber, thereby necessitating the return of the output signal to detector 30 along a looped path in the direction of arrow 35 from fiber optic sensing devices 24. In either embodiment, because the wavelength of the returned output signal from fiber optic sensing device 24 is amplified by the pump signal through SRS, the combined output signal is said to be amplified. Detector 30, after receiving the amplified output signal, interprets and quantifies the signal.

While preferred embodiments have been shown and described, various modifications and substitutions may be made thereto without departing from the spirit and scope of the invention. Accordingly, it is to be understood that the present invention has been described by way of illustration and not limitation.

1. A fiber optic sensor signal amplification system, comprising:
a light source configured to transmit an optical signal generated therein, said optical signal of said light source having a characteristic wavelength;
a detector in communication with said light source;
a signal pump in communication with said light source and said detector; and
a fiber optic sensing device remotely positioned relative to said light source, said detector, and said signal pump, said fiber optic sensing device being in photo-communication with at least one of said light source, said detector, and said signal pump through a fiber optic communication medium.

2. The fiber optic sensor signal amplification system of claim 1 wherein said light source, said detector, and said signal pump are positionable proximate a well head of a wellbore.

3. The fiber optic sensor signal amplification system of claim 2 wherein said at least one fiber optic sensing device is positionable downhole in said wellbore.

4. The fiber optic sensor signal amplification system of claim 2 wherein said system supports a plurality of said fiber optic communication mediums, each of said fiber optic communication mediums supports a fiber optic sensing device, and each of said fiber optic sensing devices is in photo-communication with said light source, said detector, and said signal pump.

5. The fiber optic sensor signal amplification system of claim 4 wherein said plurality of said fiber optic mediums are disposed in multiple wellbores.

6. The fiber optic sensor signal amplification system of claim 4 wherein said plurality of said fiber optic mediums are disposed in multiple wellbores of the same well.

7. The fiber optic sensor signal amplification system of claim 1 wherein said light source, said detector, and said signal pump are positioned remotely from a well head of a wellbore.

8. The fiber optic sensor signal amplification system of claim 7 wherein said system supports a plurality of said fiber optic communication mediums, each of said fiber optic communication mediums supporting a fiber optic sensing device, and each of said fiber optic sensing devices being in photo-communication with said light source, said detector, and said signal pump.

9. The fiber optic sensor signal amplification system of claim 8 wherein said plurality of said fiber optic mediums are disposed in multiple wellbores.

10. The fiber optic sensor signal amplification system of claim 8 wherein said plurality of said fiber optic mediums are disposed in multiple wellbores of the same well.

11. A fiber optic sensor signal amplification system, comprising:
a fiber optic communication medium configured to receive and transmit an optical signal therein;
a light source in photo-communication with said fiber optic communication medium, said light source being configured to transmit a first optical signal generated therein, said first optical signal of said light source having a characteristic wavelength spectrum;
a detector in photo-communication with said fiber optic communication medium;
a signal pump in photo-communication with said fiber optic communication medium, said signal pump being configured to transmit a second optical signal generated therein, said second optical signal from said signal pump having a characteristic wavelength spectrum that is different from said characteristic wavelength of said first optical signal from said light source, and being selected to cause stimulated scattering within said fiber optic communication medium; and
at least one fiber optic sensing device, said at least one fiber optic sensing device being in photo-communication with said fiber optic communication medium.

12. The fiber optic sensor signal amplification system of claim 11 wherein said second optical signal transmitted from said signal pump has a characteristic wavelength spectrum that is less than said characteristic wavelength of said light source and is selected to cause stimulated scattering within said fiber optic communication medium.

13. The fiber optic sensor signal amplification system of claim 11 wherein said second optical signal transmitted from said signal pump has a characteristic wavelength spectrum that is greater than said characteristic wavelength of said light source and is selected to cause stimulated scattering within said fiber optic communication medium.

14. The fiber optic sensor signal amplification system of claim 11 wherein said fiber optic communication medium extends from a well head of a wellbore to a downhole environment of said wellbore.

15. The fiber optic sensor signal amplification system of claim 13 wherein said light source is positionable proximate said well head of said wellbore.

16. The fiber optic sensor signal amplification system of claim 13 wherein said detector is positionable proximate said well head of said wellbore.

17. The fiber optic sensor signal amplification system of claim 13 wherein said signal pump is positionable proximate said well head of said wellbore.

18. The fiber optic sensor signal amplification system of claim 13 wherein said light source is positionable remote from said well head of said wellbore.

19. The fiber optic sensor signal amplification system of claim 13 wherein said detector is positionable remote from said well head of said wellbore.

20. The fiber optic sensor signal amplification system of claim 13 wherein said signal pump is positionable remote from said well head of said wellbore.

21. The fiber optic sensor signal amplification system of claim 13 wherein said light source is positionable inside said wellbore.

22. The fiber optic sensor signal amplification system of claim 13 wherein said detector is positionable inside said wellbore.

23. The fiber optic sensor signal amplification system of claim 13 wherein said signal pump is positionable inside said wellbore.

24. The fiber optic sensor signal amplification system of claim 13 wherein said at least one fiber optic sensing device is positionable downhole in said wellbore.

25. The fiber optic sensor signal amplification system of claim 11 wherein said fiber optic communication medium comprises a single mode fiber.

26. The fiber optic sensor signal amplification system of claim 11 wherein said fiber optic communication medium comprises a multi-mode fiber.

27. A method for amplifying an optical signal of a remotely located fiber optic sensor through the use of Stimulated Raman Scattering, comprising:
inputting a first optical signal generated at a specific wavelength into a fiber optic communication means;
inputting a second optical signal generated at a specific wavelength different than said specific wavelength of said first optical signal into said fiber optic communication means;
sensing a signal formed by said first optical signal using a fiber optic sensing device;
returning said signal from said fiber optic sensing device to a detector such that said second optical signal causes said first optical signal to be amplified; and
detecting said amplified signal proximate points at which said first optical signal and said second optical signal are input.

28. The method for amplifying an optical signal of a remotely located fiber optic sensor through the use of Stimulated Raman Scattering of claim 27 wherein said detecting further comprises:
interpreting said amplified signal; and
quantifying said amplified signal to determine a usable parameter.

29. The method for amplifying an optical signal of a remotely located fiber optic sensor through the use of Stimulated Raman Scattering of claim 27 further comprising:
converting said first optical signal to a signal that corresponds to a desired measurement parameter using a fiber optic sensing device; and
amplifying a returning signal from said fiber optic sensing device with said second optical signal.

30. The method for amplifying an optical signal of a remotely located fiber optic sensor through the use of Stimulated Raman Scattering of claim 27 wherein said amplified signal from said fiber optic sensing device is returned to said detector along the same path as said first and second series of optical signals.

31. The method for amplifying an optical signal of a remotely located fiber optic sensor through the use of Stimulated Raman Scattering of claim 27 wherein said combined signal from said fiber optic sensing device is returned to said detector along a different path as said first and second optical signals.

32. A method for amplifying an optical signal of a fiber optic sensor positioned downhole in a wellbore through the use of Stimulated Raman Scattering, comprising:
inputting a first optical signal generated at a specific wavelength into a fiber optic communication means at a well head of said wellbore;
inputting a second optical signal generated at a specific wavelength different than said specific wavelength of said first optical signal at said well head of said wellbore;
sensing a signal formed by said first optical signal at a downhole location using a fiber optic sensing device;
returning said signal from said fiber optic sensing device positioned downhole in said wellbore to said well head such that said second optical signal causes said first optical signal to be amplified; and
detecting a combined signal at said well head, said combined signal being defined by said returning signal and said second optical signal.

33. The method for amplifying an optical signal of a fiber optic sensor positioned downhole in a wellbore of claim 32 wherein said detecting further comprises:
interpreting said amplified signal; and
quantifying said amplified signal to determine a parameter of said wellbore.

34. The method for amplifying an optical signal of a fiber optic sensor positioned downhole in a wellbore of claim 32 further comprising:
converting said first optical signal to a signal that corresponds to a desired measurement parameter at a downhole location using said fiber optic sensing device; and
amplifying said returning signal from said fiber optic sensing device positioned downhole in said wellbore with said second optical signal.

35. The method for amplifying an optical signal of a fiber optic sensor positioned downhole in a wellbore of claim 32 wherein said amplified signal from said fiber optic sensing device is returned to said detector along the same path as said first and second optical signals.

36. The method for amplifying an optical signal of a fiber optic sensor positioned downhole in a wellbore of claim 32 wherein said amplified signal from said fiber optic sensing device is returned to said detector along a different path as said first and second optical signals.
